(19) United States
(12) Patent Application Publication
(10) Pub. No.: US 2016/0243933 A1
(43) Pub. Date: Aug. 25, 2016

(54) FILLING DEVICE

(71) Applicant: MAGNA STEYR Fuel Systems GesmbH, Sinabelkirchen (AT)

(72) Inventors: René HENDLER, Graz (AT); Dominik STEINMANN, Stubenberg (AT); Patrick ZIERLER, Brodingberg (AT)

(21) Appl. No.: 15/050,686

(22) Filed: Feb. 23, 2016

(30) Foreign Application Priority Data
Feb. 23, 2015 (EP) 15156098.4

(51) Int. Cl. B60K 15/04

(52) U.S. Cl. CPC B60K 15/04; B60K 2015/047

(57) ABSTRACT

A filling device for a metal tank, the filling device including a filler pipe composed of a polymer, and a coupling element composed of a metal to connect the filler pipe to the metal tank, the coupling element having a first connection portion upon which the filler pipe is shrink-fitted and a second connection portion to fasten the coupling element to the metal tank.

### CROSS-REFERENCE TO RELATED APPLICATIONS

The present application claims priority 35 U.S.C. §119 to European Patent Publication No. EP 15156098.4 (filed on Feb. 23, 2015), which is hereby incorporated by reference in its entirety.

### TECHNICAL FIELD

Embodiments relate to a filling device for a metal tank, a tank device comprising such a filling device, and a method for producing a filling device.

### BACKGROUND

A filling device permits the filling of a tank, in particular a fuel tank of a motor vehicle, and to this end uses a filler pipe which typically forms a fluid connection between a filler neck and a tank. The filler pipe in this case has to be connected at one end to the filler neck and at the other end to the tank in a fluid-tight manner. For attaching a filler pipe to a tank it is known to provide a tank connector pipe on the tank and to connect the filler pipe via intermediate elements to the tank connector pipe. In particular, mounted pipe connectors or pressed-on steel interfaces are used as the intermediate elements.

In recent times, filler pipes made of plastics material have been increasingly used. If said filler pipes are to be connected to a tank made of metal, in addition to the usual connection problems, a suitable transition also has to be provided between the metal and the plastics material.

### SUMMARY

Embodiments relate to a filling device comprising a filler pipe which may be connected in a simple and reliable manner to a metal tank, a tank device comprising such a filling device, and a method for producing the filling device which is simple and cost-effective.

In accordance with embodiments, a filling device for a metal tank comprises at leas one of: a filler pipe composed of a polymer, and a coupling element composed of metal to connect the filler pipe to the metal tank, wherein the plastics pipe is shrink-fitted onto a pipe connection portion of the metal part.

In accordance with embodiments, a coupling element composed of a metal, such as, for example, stainless steel, is arranged between the plastics filler pipe and the metal tank. The plastics filler pipe is to be shrink-fitted on the coupling element, in particular, during the course of the production of the plastics filler pipe.

In accordance with embodiments, the filler pipe may be composed of, for example, High Density Polyethylene (HDPE).

In accordance with embodiments, the coupling element may be of rotationally symmetrical construction. For example, the coupling element may be a simple rotary part, and thus, may be produced in a simple manner.

In accordance with embodiments, the coupling element may also have a non-rotationally symmetrical shape, in particular, an oval or trilobular cross-section, in order to form a positive connection against rotation of the filler pipe relative to the coupling element.

In accordance with embodiments, the coupling element may also be an extruded component, precision cast component, gravity die cast component, injection-moulded component, Metal Injection Moulding (MIM) component or sintered component, in particular, a Selective Laser Sintering (SLS) component.

In accordance with embodiments, a first collar acting as a stop may be arranged on the coupling element between the pipe connection portion, in which the filler pipe is to be in contact against the coupling element, and a tank connection portion of the coupling element, which is configured to connect to the metal tank, so that the shrink-fitted filler pipe is to contact on the front face against the first collar.

In accordance with embodiments, a second collar may be arranged in the pipe connection portion, in particular, at the end of the coupling element facing the filler pipe, so that the second collar acts as an undercut for the shrink-fitted filler pipe. The second collar, thus, prevents an axial displacement of the filler pipe.

In accordance with embodiments, at least one filler-pipe annular seal is arranged between the first collar and the second collar, said annular seal forming a seal between the filler pipe and the coupling element. The annular seal may be inserted, in particular, into an annular groove of the coupling element. Embodiments are not limited to a single annular seal, and thus, may encompass two annular seals inserted in this region.

In accordance with embodiments, in each case “annular seal” and “annular groove” are understood as a closed shape which follows the shape of the coupling element, such as, for example, also an oval and trilobular shape.

In accordance with embodiments, an “annular seal” may also be designed as a specifically-shaped seal, such as, for example, an X-shaped ring. An “annular groove” may, therefore, also be adapted to the specific shape of such an annular seal.

In accordance with embodiments, at least one annular groove, such as, for example, two annular grooves, may be arranged in a region of the coupling element remote from the filler pipe, i.e., in the tank connection portion, for receiving a tank annular seal.

In accordance with embodiments, a tank device may comprise a metal tank having a metal tank connector pipe and a filling device having the features set forth herein, wherein the coupling element is fastened to the metal tank connector pipe.

In accordance with embodiments, the coupling element may be inserted into the metal tank connector pipe and, in particular, is fixed by a fixing spring in the metal tank connector pipe.

In accordance with embodiments, a method for producing a filling device provides that the filler pipe is shaped by heating, in particular is blow-moulded, or is heated after production, for example, after the injection-moulding process, and the coupling element is pressed into the filler pipe which is still warm. During the pressing process the filler pipe may have a predetermined temperature, such as at least 70 degrees Celsius, or above 80 degrees Celsius, and therefore, is still correspondingly flexible. Upon cooling, the filler pipe is shrink-fitted onto the coupling element so that the shrink-fitting already results in a sealing action.

In accordance with embodiments, after the production, in particular, the blow-moulding, of the filler pipe, the edges of the filler pipe are to be rounded off, i.e., trimmed to size, particularly while the filler pipe is still warm and before the pressing and shrink-fitting processes.

In accordance with embodiments, after the production, in particular, the blow-moulding and optionally the rounding-off of the edges of the filler pipe, the coupling element is to be inserted and pressed therein, so that said filler pipe contacts against the stop on the first collar of the coupling element.

In accordance with embodiments, after shrink-fitting the filler pipe, the second collar of the coupling element forms an undercut which fixes the filler pipe to the coupling element. The sealing action between the filler pipe and the coupling element is also enhanced by the second collar on the coupling element.

### DRAWINGS

Embodiments will be illustrated by way of example in the drawings and explained in the description below.

FIG. 1 illustrates a side view of a filling device, in accordance with embodiments.

### DESCRIPTION

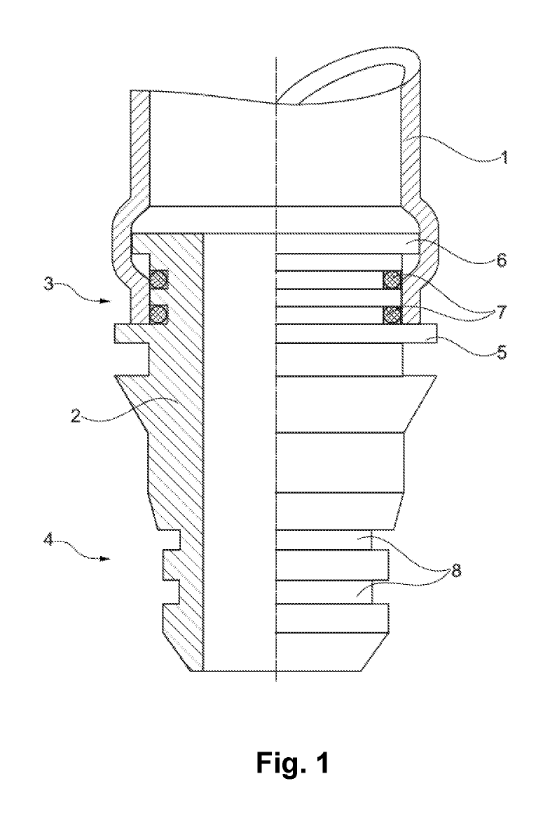

As illustrated in FIG. 1, a filling device in accordance with embodiments includes a filler pipe 1 is shown as a longitudinal section, and a coupling element 2 in the right-hand half of the drawing is shown in a view from the front. The shaped portions of the coupling element 2 are more visible, and in the left-hand image half the coupling element 2 is shown in section, so that it is possible to distinguish more clearly the coupling element 2 component.

The filler pipe 1 may be composed of a polymer while the coupling element 2 may be composed of a metal. The coupling element 2 may function as a rotary part and have substantially the shape or cross-section of a hollow cylinder. The coupling element 2 has a pipe connection portion 3, upon which the filler pipe 1 may be shrink-fitted therein onto the coupling element 2. Additionally, the coupling element 2 has a tank connection portion 4 at an opposite end of the pipe connection portion 3, and which is configured to fasten the coupling element 2 to a tank, in particular, to a tank pipe.

A first collar 5 of the coupling element 2 is arranged between the pipe connection portion 3 and the tank connection portion 4 of the coupling element 2. The first collar acting is to function as a stop for the filler pipe 1, so that the shrink-fitted filler pipe 1 is to contact on the front face thereof against the first collar 5.

A second collar 6 of the coupling element 2 is arranged at a distal end of the coupling element 2 facing the filler pipe 1. The second collar 6 is to act as an undercut for the shrink-fitted filler pipe 1.

Filler-pipe annular seals 7 are arranged between the filler pipe 1 and the coupling element 2. The filler-pipe annular seals 7 are arranged between the first collar 5 and the second collar 6.

Two annular grooves 8 are arranged in a region of the coupling element 2 remote from the filler pipe 1, i.e., in the tank connection portion 4, and are to receive in each case a tank annular seal.

The terms “coupled,” “fasten,” and “connected” may be used herein to refer to any type of relationship, direct or indirect, between the components in question, and may apply to electrical, mechanical, fluid, optical, electromagnetic, electromechanical or other connections. In addition, the terms “first,” “second, etc. are used herein only to facilitate discussion, and carry no particular temporal or chronological significance unless otherwise indicated.

This written description uses examples to disclose the invention, including the preferred embodiments, and also to enable any person skilled in the art to practice the invention, including making and using any devices or systems and performing any incorporated methods. The patentable scope of embodiments is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims. Aspects from the various embodiments described, as well as other known equivalents for each such aspects, may be mixed and matched by one of ordinary skill in the art to construct additional embodiments and techniques in accordance with principles of this application.

### LIST OF REFERENCE SIGNS

1 Filler pipe
2 Coupling element
3 Pipe connection portion
4 Tank connection portion
5 First collar
6 Second collar
7 Filler-pipe annular seal
8 Annular groove

What is claimed is:

1. A filling device for a metal tank, the filling device comprising:
a filler pipe composed of a polymer; and
a coupling element composed of a metal to connect the filler pipe to the metal tank, the coupling element having a first connection portion upon which the filler pipe is shrink-fitted and a second connection portion to fasten the coupling element to the metal tank.

2. The filling device of claim 1, wherein the coupling element comprises a first collar arranged between the first connection portion and the second connection portion of the coupling element, the first collar to act as a stop upon which the filler pipe contacts.

3. The filling device of claim 2, wherein the first collar has a front face upon which the filler pipe contacts.

4. The filling device of claim 2, wherein the coupling element comprises a second collar at the first connection portion to act as an undercut for the filler pipe.

5. The filling device of claim 4, wherein the second collar is arranged at an end of the coupling element facing the filler pipe.

6. The filling device of claim 4, further comprising at least one annular seal arranged between the filler pipe and the coupling element.

7. The filling device of claim 4, further comprising at least one annular seal arranged between the first collar and the second collar.

8. The filling device of claim 1, wherein the coupling element has at least one annular groove arranged adjacent the second connection portion, and which is to receive an annular seal.

9. The filling device of claim 1, wherein the coupling element has at least two annular groove arranged adjacent the second connection portion, and which is to receive an annular seal.

10. The filling device of claim 1, wherein the coupling element has an oval or trilobular cross-section.

11. A tank device comprising:
a tank composed of a metal, and which has a tank connector pipe;
a filling device including a filler pipe composed of a polymer, and a coupling element composed of a metal to connect the filler pipe to the metal tank, the coupling element having a first connection portion upon which the filler pipe is shrink-fitted and a second connection portion to fasten the coupling element to the tank connector pipe.

12. The tank of claim 11, wherein the coupling element is inserted into the metal tank connector pipe, and is fixed by a fixing spring in the tank connector pipe.

13. A method of producing a filling device, the method comprising:
providing the filling device having a filler pipe composed of a polymer, and a coupling element composed of a metal to connect the filler pipe to the metal tank, the coupling element having a first connection portion upon which the filler pipe is shrink-fitted and a second connection portion to fasten the coupling element to the tank connector pipe;
heating the filler pipe is produced by heating; and
pressing the coupling element into the filler pipe while the filler pipe is heated.

14. The method of claim 13, wherein the filler pipe is produced by blow-moulding.

15. The method of claim 13, wherein the filler pipe is heated after production.

16. The method of claim 13, wherein pressing the coupling element comprises pressing the coupling element into the filler pipe so that the filler pipe bears against a stop on a first collar of the coupling element.

17. The method of claim 13, wherein pressing the coupling element comprises pressing the coupling element into the filler pipe so that the filler pipe covers a second collar of the coupling element.

18. The method of claim 17, wherein at least after cooling and shrink-fitting of the filler pipe, the second collar acts as an undercut for the shrink-fitted filler pipe.

19. The method of claim 13, further comprising rounding off edges of the filler pipe after production of the filler pipe.
